(19) United States
(12) Patent Application Publication
(10) Pub. No.: US 2026/0003142 A1
(43) Pub. Date: Jan. 1, 2026

(54) OPTICAL INTERCONNECT OF COMPUTING MODULES

(71) Applicant: Omattrix Ltd., Co., Santa Clara, CA (US)

(72) Inventors: Lung Kevin Law, Santa Clara, CA (US); Deco Lee, Santa Clara, CA (US)

(73) Assignee: Omattrix Ltd., Co., Santa Clara, CA (US)

(21) Appl. No.: 19/313,320

(22) Filed: Aug. 28, 2025

(51) Int. Cl. G02B 6/42; G02F 1/03

(52) U.S. Cl. CPC G02B 6/425; G02B 6/4214; G02B 6/4274; G02F 1/0311

(57) ABSTRACT

The present disclosure relates to optical interconnect technology between computing modules, and particularly to a computing module that includes an optical interconnect unit. According to one aspect of the present disclosure, there is provided a computing module, the computing module comprising: a substrate; a data processing unit disposed on a surface of or inside the substrate; a signal switching unit disposed on the surface of or inside the substrate; an optical interconnect unit; and an optical waveguide. In the computing module, optical signal transmission between the signal switching unit and the optical interconnect unit is implemented via the optical waveguide, the optical interconnect unit comprising: a collimating lens array in optical connection with the optical waveguide; a control unit disposed near the collimating lens array; and a microcontroller disposed on the surface of or inside the substrate, wherein the microcontroller is configured to, based on an optical signal intensity measured at the signal switching unit, adjust a refractive index or a position of the collimating lens array via the control unit to improve an optical coupling efficiency between the optical waveguide and the optical interconnect unit.

### TECHNICAL FIELD

The present disclosure pertains to optical interconnect technology between computing modules, and particularly to a computing module comprising an optical interconnect unit.

### BACKGROUND

Large language models (LLMs) are undergoing leap-forward development: their parameter scale has soared from billions to trillions, the volume of training data has surpassed the trillion-token mark, and the computing capacity required for a single complete training run has reached a staggering 1023 FLOPS. The core challenge in training large models lies in the efficient flow of data between computing nodes. In a complex-model parallel-processing scenario, for example, it is required that model parameters be shared and stored across different computing modules or nodes. As such, a low-loss, high-stability optical interconnect among multiple nodes has become a key constraint on scaling model parallelism.

### SUMMARY

According to one aspect of the present disclosure, there is provided a computing module, the computing module comprising: a substrate; a data processing unit disposed on a surface of or inside the substrate; a signal switching unit disposed on the surface of or inside the substrate; an optical interconnect unit; and an optical waveguide. In the computing module, optical signal transmission between the signal switching unit and the optical interconnect unit is implemented via the optical waveguide, the optical interconnect unit comprising: a collimating lens array in optical connection with the optical waveguide; a control unit disposed near the collimating lens array; and a microcontroller disposed on the surface of or inside the substrate. The microcontroller is configured to, based on an optical signal intensity measured at the signal switching unit, adjust a refractive index or a position of the collimating lens array via the control unit to improve optical coupling efficiency between the optical waveguide and the optical interconnect unit.

According to another aspect of the present disclosure, there is provided a computing module, the computing module comprising a substrate; a data processing unit disposed on a surface of or inside the substrate; a signal switching unit disposed on the surface of or inside the substrate; an optical interconnect unit; and an optical waveguide. In the computing module, optical signal transmission between the signal switching unit and the optical interconnect unit is implemented via the optical waveguide, the optical interconnect unit comprising: a control unit; a collimating lens array in optical connection with the optical waveguide via the control unit; and a microcontroller disposed on the surface of or inside the substrate. The microcontroller is configured to, based on an optical signal intensity measured at the signal switching unit, control a propagation direction of light rays between the control unit and the collimating lens array by means of the control unit to improve optical coupling efficiency between the optical waveguide and the optical interconnect unit.

The optical coupling efficiency between an optical interconnect port and an optical waveguide is typically affected by factors such as assembly tolerance, operating temperature and full-lifecycle performance degradation. In certain embodiments of the present disclosure, by using the control unit provided in the computing module to change parameters of the collimating lens array (e.g., refractive index and position), or to change the propagation direction of light rays exiting from and incident to the collimating lens array, coupling loss can be dynamically compensated, thus improving optical coupling efficiency.

### BRIEF DESCRIPTION OF DRAWINGS

The above and/or other aspects and advantages of the present disclosure will become more explicit and lucid from the following description of various embodiments in conjunction with the accompanying drawings, in which the identical or similar units are denoted by the same reference numerals. The drawings include:

FIGS. 1 and 2 are schematic diagrams of a computing module according to an embodiment of the present disclosure, wherein FIG. 1 is a plan view of the illustrated computing module, and FIG. 2 is a cross-sectional view taken along line A-A in FIG. 1.

FIG. 3 is a schematic diagram illustrating the implementation of dynamic compensation according to an embodiment of the present disclosure.

FIG. 4 is a schematic diagram of a computing module interconnection according to an embodiment of the present disclosure.

FIG. 5 is a schematic diagram of a computing module interconnection according to another embodiment of the present disclosure.

FIGS. 6 and 7 are schematic diagrams of a computing module according to an embodiment of the present disclosure, wherein FIG. 6 is a plan view of the illustrated computing module, and FIG. 7 is a cross-sectional view taken along line B-B in FIG. 6.

FIG. 8 is a schematic diagram of a computing module interconnection according to another embodiment of the present disclosure.

FIGS. 9 and 10 are schematic diagrams of a computing module according to an embodiment of the present disclosure, wherein FIG. 9 is a plan view of the illustrated computing module, and FIG. 10 is a cross-sectional view taken along line C-C in FIG. 9.

### DETAILED DESCRIPTION OF EMBODIMENTS

The present disclosure will now be described in greater detail below with reference to the accompanying drawings, in which illustrative embodiments of the present disclosure are shown. The present disclosure may, however, be embodied in many different forms and should not be construed as limited solely to the embodiments set forth herein. Rather, these embodiments are provided so that the present disclosure will be thorough and complete and its scope will be fully conveyed to those skilled in the art.

In this Specification, the term “comprise” and its analogues should be interpreted as open-ended inclusion, i.e., “comprising, but not limited to”; the term “based on” should be interpreted as “based at least in part on”; and the term “an embodiment” or “the embodiment” should be interpreted as “at least one embodiment”.

In this Specification, a phrase such as “component A is disposed on a surface of component B” means that at least a part of component A is located outside the surface of component B; and a phrase such as “component A is disposed inside component B” means that all parts of component A are located inside component B.

In this Specification, the term “computing module” refers to a modular unit that integrates multiple circuits or components (e.g., semiconductor chips) to provide data processing, signal switching and high-speed optical communication interface functions.

In this Specification, the term “main surface” refers to the surface of a substrate intended to carry core functional components (e.g., core computing components such as computing chips, memory chips, and in-memory computing chips), which can serve as the primary area for component installation.

In this Specification, the term “side surface” refers to the other surfaces of the substrate besides the main surface, which are primarily intended for functions such as edge connection, mechanical fixation and signal transition.

In this Specification, the term “optical connection” refers to the associated state formed by the physical alignment of two optical devices (e.g., an optical waveguide and a lens, a lens and an optical fiber) that enables the transmission of optical signals.

In this Specification, the term “optical coupling” refers to the energy transfer process when an optical signal is transmitted from one optical device/medium (e.g., an optical waveguide) to another device/medium (e.g., a lens). Typically, the transmission loss of the optical signal in this energy transfer process is measured by “optical coupling efficiency” (optical power entering a receiving end/total power from a transmitting end).

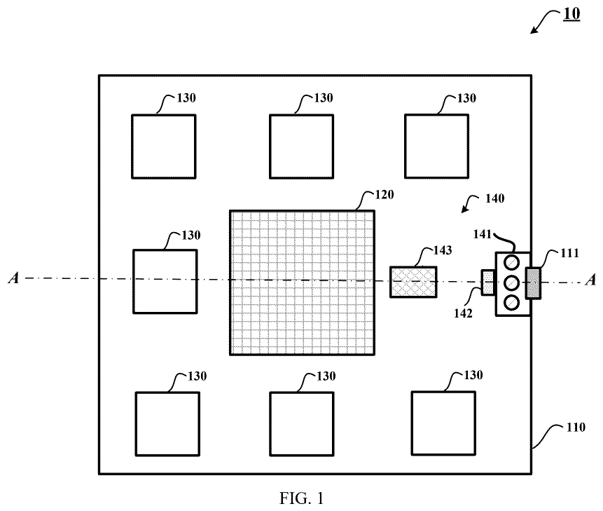

FIGS. 1 and 2 are schematic diagrams of a computing module according to an embodiment of the present disclosure, wherein FIG. 1 is a plan view of the illustrated computing module, and FIG. 2 is a cross-sectional view taken along line A-A in FIG. 1.

Referring to FIGS. 1 and 2, the illustrated computing module 10 comprises a substrate 110, a signal switching unit 120, a data processing unit 130, an optical interconnect unit 140 and an optical waveguide 150. In the illustrated embodiment, the substrate 110 serves as a carrier for the various functional units. Exemplarily, the substrate 110 may be, for example, a glass substrate or a printed circuit board. As shown in FIGS. 1 and 2, a microstructure 111 for interconnecting with other computing modules is further disposed on a side surface of the substrate 110. The signal switching unit 120 and the data processing unit 130 are disposed on a main surface of the substrate 110 and communicate with each other via electrical connection or optical connection.

In this embodiment, optionally, the signal switching unit 120 is implemented in the form of a photonic integrated circuit integrating optoelectronic conversion and optical switching functions. The photonic integrated circuit may comprise, for example, a silicon photonics module integrating optoelectronic conversion and optical switching functions (such as wavelength division multiplexing), or a monolithically integrated all-optical-electrical fusion chip that simultaneously implements optoelectronic conversion, optical switching and electrical processing. Correspondingly, the data processing unit 130 is an electrical chip or an electronic integrated circuit, which may be one of the following chips or a combination thereof: computing chips (such as central processing units (CPUs), graphics processing units (GPUs), application-specific integrated circuits (ASICs), and field-programmable gate arrays (FPGAs)), memory chips (e.g., graphics DRAM (GDDR), high bandwidth memory (HBM) and static random-access memory (SRAM)) and in-memory computing chips.

In this embodiment, as another option, the signal switching unit 120 may also only comprise an optical-switching chip. Examples of the optical-switching chip comprise, but are not limited to, a silicon photonics optical-switching chip, a planar lightwave circuit optical-switching chip, a micro-electromechanical system (MEMS) optical-switching chip and the like. Correspondingly, the data processing unit 130, in addition to comprising core computing components such as computing chips, memory chips and in-memory computing chips, may further comprise an optoelectronic converter chip to convert optical signals from the signal switching unit into electrical signals suitable for processing by the core computing components, and to convert electrical signals from the core computing components into optical signals suitable for processing by the signal switching unit. In certain specific implementations, the core computing components and the optoelectronic converter chip can be packaged together using various technologies to obtain a multi-chip integrated component or a heterogeneously integrated chip.

In this embodiment, optical signal transmission between the signal switching unit 120 and the optical interconnect unit 140 is implemented via the optical waveguide 150. In this Specification, unless otherwise specified, the transmission of optical signals generally encompasses both bidirectional and unidirectional transmission. Exemplarily, the optical waveguide 150 is composed of multiple parallel optical transmission channels (i.e., in the form of a “waveguide array”), wherein each waveguide corresponds to one wavelength or one data channel. An end of the optical waveguide 150 comprises a fan-out region, the region functioning to “expand” a densely arranged multi-channel waveguide array into a sparsely arranged multi-channel waveguide array that matches a fiber adapter unit (FAU), which is essentially a spatial reconstruction of the waveguide array by designing the path of each waveguide (e.g., bending at a graded angle, branching, or merging), the originally compact array is gradually spaced apart to eventually correspond one-to-one with the channels of a fiber array.

Referring further to FIGS. 1 and 2, the optical interconnect unit 140 comprises a collimating lens array 141, a control unit 142 and a microcontroller 143. The optical connection between the collimating lens array 141 and the optical waveguide 150 is implemented by disposing the collimating lens array 141 in the fan-out region of the optical waveguide 150 and making each lens unit correspond one-to-one with a channel of the fanned-out waveguide array. The function of the lens units is to collimate the divergent light fanned out from the waveguide and expand the optical mode field.

In this embodiment, the lens units of the collimating lens array 141 are made of a polymer material having an electro-optic property or a thermo-optic property, and the refractive index of such materials varies with the electric field applied thereon or with the temperature of the material. The types of the aforementioned polymer materials comprise, but are not limited to, for example, guest-host type, side-chain type, main-chain type and cross-linked type. For a material with an electro-optic property, its refractive index is altered by controlling the electric field applied onto the lens units of the collimating lens array 141, thereby dynamically compensating for the loss in optical coupling efficiency caused by various factors (including, but not limited to, for example, assembly tolerance, full-lifecycle performance degradation of the computing module's components, temperature fluctuations, etc.) or improving optical coupling efficiency. Similarly, for a material with a thermo-optic property, its refractive index is changed by controlling the temperature of the lens units of the collimating lens array 141, thereby improving optical coupling efficiency between the optical waveguide and the optical interconnect unit.

In this embodiment, the control unit 142 in the form of an electrode or a heater (e.g., a resistance wire) is disposed near the collimating lens array 141 to apply an electric field to or heat the lens units. Exemplarily, as shown in FIGS. 1 and 2, the electrode or heater can be arranged around each of the lens units (shown as circles in the figures) of the collimating lens array 141, thereby enabling adjustment to the refractive index of individual lens units. The control unit 142 is controlled by a microcontroller 143, wherein the microcontroller can be disposed on the surface of or inside the substrate 110 and be electrically connected to the control unit 142.

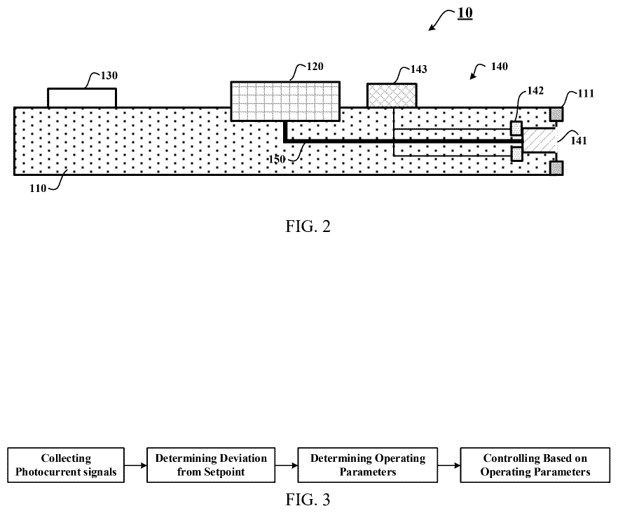

FIG. 3 is a schematic diagram illustrating the implementation of dynamic compensation according to an embodiment of the present disclosure. As shown in FIG. 3, a monitor photodetector (MPD) is intended to collect photocurrent signals at an optical coupling region of the signal switching unit 120, the signal corresponding to the intensity or power of the optical signal entering the optical waveguide 150 from the collimating lens array 141. The microcontroller 143, based on the collected photocurrent signals, determines a degree of deviation of the intensity of the optical signal entering the optical waveguide 150 from a setpoint (e.g., a design value) (which can be employed to indicate optical coupling efficiency between the optical waveguide 150 and the optical interconnect unit 140), and the microcontroller, based on this degree of deviation, determines operating parameters of the control unit (e.g., a current flowing through the heater or a voltage applied across the electrode). Subsequently, the control unit 142 operates under the determined operating parameters to enable the lens units to have the desired refractive index. Optionally, a correspondence between the degree of deviation from the setpoint and the operating parameters of the control unit can be calibrated through experiments, and be stored in the microcontroller in the form of a table for invocation when determining the operating parameters.

In a variation of this embodiment, a piezoelectric-ceramic element or a shape-memory alloy can be employed as the control unit. Specifically, the control unit 142 can be disposed around the collimating lens array 141. The microcontroller 143, based on the degree of deviation of the measured optical signal intensity from the setpoint, controls the voltage applied across or the current flowing through the piezoelectric-ceramic element or the shape-memory alloy to change its volume, thus in turn changing the position of the collimating lens array 141 to achieve dynamic compensation for the loss in optical coupling efficiency.

In the embodiment shown in FIGS. 1 and 2, a light-emitting surface or a light-incident surface of the collimating lens array 141 is located on a side surface of the substrate 110. As should be noted, the illustrated position of the light-emitting surface (light-incident surface) is merely exemplary; in other embodiments, it can also be located on the main surface of the substrate.

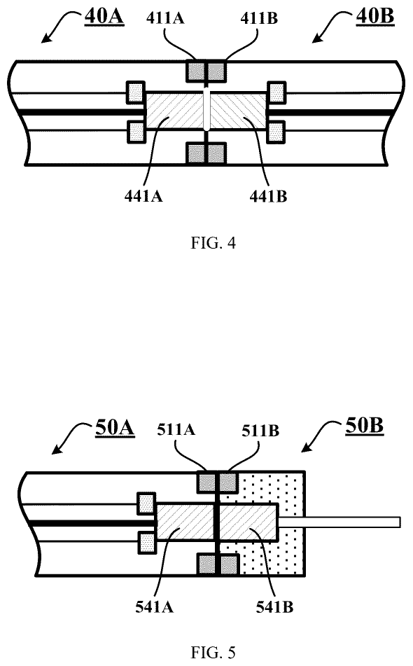

FIG. 4 is a schematic diagram of a computing module interconnection according to an embodiment of the present disclosure, where the interconnect mode shown is applicable to the interconnection of the computing modules illustrated in FIGS. 1 and 2. To simplify description, only a partial cross-sectional structure of the computing module is shown here. Referring to FIG. 4, microstructures 411A and 411B that are adapted to nest with each other are disposed on the side surfaces of substrates 410A and 410B of computing modules 40A and 40B, such that when the microstructures 411A and 411B are nested with each other, the collimating lens arrays 441A and 441B of the computing modules 40A and 40B will be aligned with each other. The aforementioned microstructures comprise, but are not limited to, male and female connectors, magnetic structures and the like. Alternatively, close-distance, non-contact interconnection between two computing modules can also be achieved by means of high-precision pick-and-place equipment.

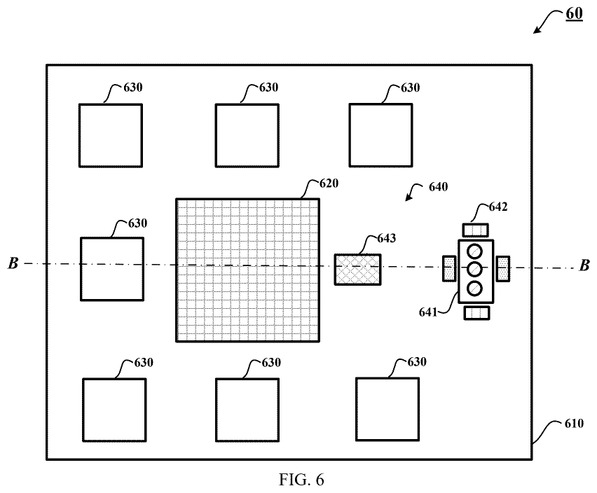

FIG. 5 is a schematic diagram of a computing module interconnection according to another embodiment of the present disclosure, where the interconnect mode shown is applicable to the interconnection of the computing modules illustrated in FIGS. 1 and 2. Likewise, to simplify description, only a partial cross-sectional structure of the computing module is shown here. Referring to FIG. 5, a microstructure 511A adapted to nest with a microstructure 511B of a fiber adapter unit 50B is disposed on a side surface of a substrate 510 of a computing module 50A. When the microstructures 511A and 511B are nested with each other, a collimating lens array 541A of the computing module 50A and a collimating lens array 541B of the fiber adapter unit 50B are aligned with each other. The aforementioned microstructures comprise, but are not limited to, male and female connectors, magnetic structures and the like.

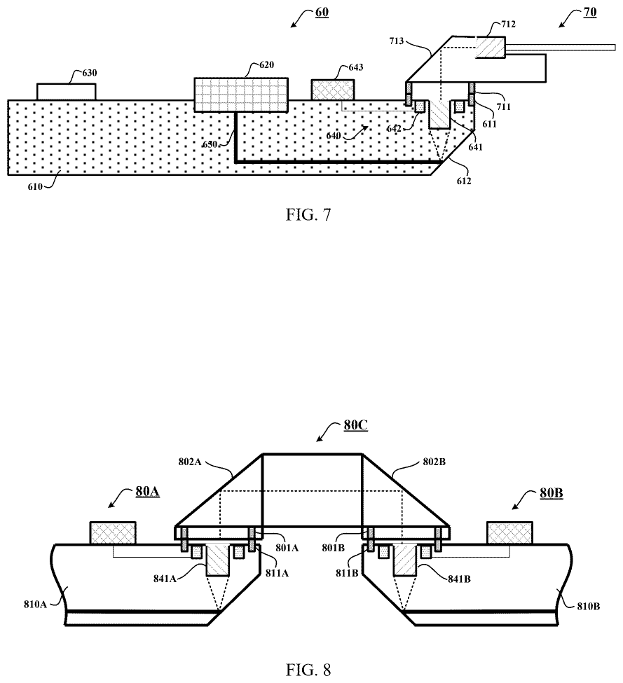

FIGS. 6 and 7 are schematic diagrams of a computing module according to an embodiment of the present disclosure, wherein FIG. 6 is a plan view of the illustrated computing module, and FIG. 7 is a cross-sectional view taken along line B-B in FIG. 6. To avoid redundancy, the following description of this embodiment mainly covers content that is different from the embodiment shown in FIGS. 1 and 2.

As shown in FIGS. 6 and 7, a computing module 60 comprises a substrate 610, a signal switching unit 620, a data processing unit 630, an optical interconnect unit 640 and an optical waveguide 650, the optical interconnect unit 640 comprising a collimating lens array 641, a control unit 642 and a microcontroller 643.

In this embodiment, a piezoelectric-ceramic element or a shape-memory alloy serves as the control unit 642. Referring to FIG. 7, the control unit 642 is arranged around the collimating lens array 641. Exemplarily, a corresponding control unit is arranged around each lens unit (shown as a circle in the figure), thereby enabling adjustment of a position of individual lens units. The microcontroller 643 can perform dynamic compensation for the loss in optical coupling efficiency in a manner similar to that shown in FIG. 3. Specifically, the microcontroller 643 determines a degree of deviation of optical signal intensity from a setpoint based on a photocurrent signal at an optical coupling region of the signal switching unit 620, and determines operating parameters of the control unit 642 (e.g., a voltage applied across the piezoelectric-ceramic element or the shape-memory alloy) based on the degree of deviation. Subsequently, the control unit 642 undergoes a volume change under the determined operating parameters, thus in turn causing the required change in the position of the collimating lens array 641.

Different from the embodiment shown in FIGS. 1 and 2, a light-emitting surface or a light-incident surface of the collimating lens array 641 is located on a main surface of the substrate 610. To enable light rays transmitting within the horizontally extending optical waveguide 650 to reach the collimating lens array 641, and light rays exiting from the collimating lens array 641 to reach the optical waveguide 650, as shown in FIG. 7, a bottom surface of the substrate 610 comprises a reflective surface 612 as a mirror; light rays (shown as dashed lines in the figure) exiting from the optical waveguide 650 or the collimating lens array 641 are guided to the collimating lens array 641 or the optical waveguide 650 after being reflected by the mirror surface. In a variation of this embodiment, the mirror is disposed at a suitable position inside the substrate 610 to enable transmission of light rays between the optical waveguide 650 and the collimating lens array 641.

Referring further to FIGS. 6 and 7, a microstructure 611 adapted to nest with a microstructure 711 of a fiber adapter unit 70 is disposed on the main surface of the substrate 610. When the microstructures 611 and 711 are nested with each other, light rays (shown as dashed lines in the figure) exiting from a collimating lens array 641 or 712 are reflected by a mirror 713 within the fiber adapter unit 70 before reaching the collimating lens array 712 or 641.

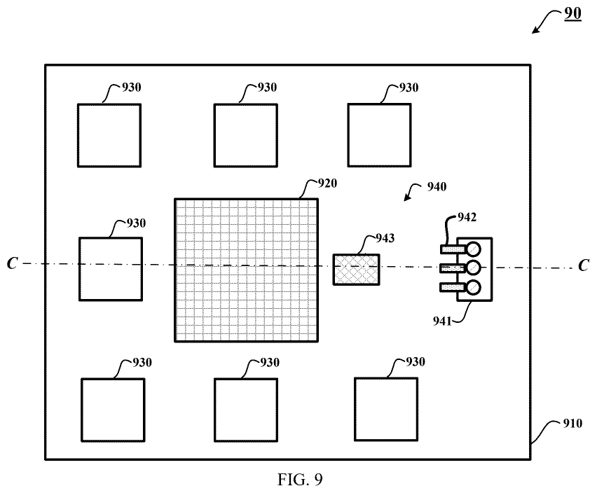

FIG. 8 is a schematic diagram of a computing module interconnection according to another embodiment of the present disclosure, where the interconnect mode shown is applicable to the interconnection of the computing modules shown in FIGS. 6 and 7. To simplify description, only a partial cross-sectional structure of the computing modules is shown here. Referring to FIG. 8, microstructures 811A and 811B are disposed on main surfaces of substrates 810A and 810B near where a light-emitting surface or light-incident surface of a collimating lens array is positioned. A bridge component 80C, as a detachable component independent of the computing modules 80A and 80B, comprises microstructures 801A and 801B and mirror surfaces 802A and 802B. When the microstructures 811A and 811B are nested with the microstructures 801A and 801B, respectively, light rays (shown as dashed lines in the figure) exiting from a collimating lens array 841A or 841B of the computing module 80A or 80B are reflected by the mirror surfaces 802A and 802B to reach the collimating lens array 841B or 841A of the computing module 80B or 80A.

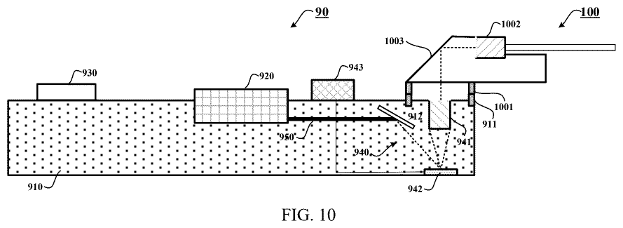

FIGS. 9 and 10 are schematic diagrams of a computing module according to an embodiment of the present disclosure, wherein FIG. 9 is a plan view of the illustrated computing module, and FIG. 10 is a cross-sectional view taken along line C-C in FIG. 9. To avoid redundancy, the following description of this embodiment mainly covers content that is different from the embodiments shown in FIGS. 1, 2, 6, and 7.

The computing module 90 shown in FIGS. 9 and 10 comprises a substrate 910, a signal switching unit 920, a data processing unit 930, an optical interconnect unit 940 and an optical waveguide 950, the optical interconnect unit 940 comprising a collimating lens array 941, a control unit 942 and a microcontroller 943.

Different from the embodiments described above, in this embodiment, the control unit 942 per se is a component of an optical signal transmission path. Specifically, as shown in FIG. 10, the control unit 942 is located between the optical waveguide 950 and the collimating lens array 941 and serves the function of deflecting light rays. Light rays from the optical waveguide 950 reach the control unit 942 after being reflected by a mirror 912 disposed inside the substrate 910, and are then guided by the control unit 942 to the collimating lens array 941. On the other hand, light rays from the collimating lens array 941 are guided by the control unit 942 to the mirror 912 and are subsequently reflected to the optical waveguide 950. In this embodiment, a deflection angle of the control unit 942 is adjustable, thereby enabling control over a propagation direction of light rays between the control unit 942 and the collimating lens array 941 to allow more light to enter the optical waveguide or the collimating lens array. As specific examples, the control unit 942 can be enabled using optical elements such as a MEMS mirror or a phase-only liquid crystal on silicon.

The microcontroller 943 also performs dynamic compensation for the loss in optical coupling efficiency in a manner similar to that shown in FIG. 3. For example, in the case where the control unit 942 is a MEMS mirror, the microcontroller 943 determines a degree of deviation of optical signal intensity from a setpoint based on a photocurrent signal at an optical coupling region of the signal switching unit 920, and determines a deflection angle of the MEMS mirror based on the degree of deviation, thereby exerting control over a propagation direction of light rays by enabling the MEMS mirror to have the determined deflection angle. As another example, in the case where the control unit 942 is a phase-only liquid crystal on silicon, the microcontroller 943 determines the degree of deviation of the optical signal intensity from the setpoint based on the photocurrent signal at the optical coupling region, and determines phase distribution of liquid-crystal molecules in the phase-only liquid crystal on silicon based on the degree of deviation, thereby adjusting the phase distribution of the liquid-crystal molecules to make the light rays propagate along a desired direction to improve optical coupling efficiency.

In this embodiment, as shown in FIG. 9, the control unit 942 comprises multiple control elements, and each lens unit (shown as a circle in the figure) of the collimating lens array 141 is equipped with a corresponding control element, thus enabling individual control over the propagation direction of light rays between each of the lens units and the control elements.

Referring further to FIG. 10, a microstructure 911 adapted to nest with a microstructure 1001 of a fiber adapter unit 100 is disposed on a main surface of the substrate 910. When the microstructures 1001 and 911 are nested with each other, light rays exiting from the collimating lens array 941 or 1002 reach the collimating lens array 1002 or 941 after being reflected by a mirror 1003 within the fiber adapter unit 100.

As should be noted, the embodiments described above can have various transformations or modifications. Furthermore, different embodiments or examples and their features can be incorporated and combined in various ways without contradiction. For example, the signal processing unit can have other quantities and layouts in addition to those shown in the figures. As another example, in one variation, each of the computing modules can comprise multiple optical interconnect units, and the light-emitting or light-incident surfaces of the collimating lens arrays of these optical interconnect units can either all be located on the side surface or the main surface of the substrate, or be partially located on the side surface while others are on the main surface. As yet another example, each of the computing modules can simultaneously provide multiple modes to interconnect with other computing modules, including but not limited to the direct connection mode as described above (e.g., as shown in FIG. 4), the indirect connection mode via the fiber adapter unit (e.g., as shown in FIGS. 5, 7, and 10), and the indirect connection mode via the bridge component (e.g., as shown in FIG. 8).

Although only certain specific embodiments of the present disclosure are described, those of ordinary skill in the art should understand that the present disclosure can be implemented in many other forms without departing from its spirit and scope. Therefore, the presented examples and embodiments are to be deemed illustrative, rather than restrictive, and the present disclosure may encompass various modifications and replacements without departing from the spirit and scope of the present disclosure as defined by the appended claims.

The embodiments and examples set forth herein are provided to best illustrate the embodiments of the present technology and its particular applications, and thereby to enable those skilled in the art to implement and use the present disclosure. Nevertheless, those skilled in the art will know that the above description and examples are furnished for illustrative and exemplary purposes solely. The presented description is not intended to be exhaustive or to limit the present disclosure to the precise form disclosed.

What is claimed is:

1. A computing module, comprising: a substrate; a data processing unit disposed on a surface of or inside the substrate; a signal switching unit disposed on the surface of or inside the substrate;
an optical interconnect unit; and an optical waveguide, wherein optical signal transmission between the signal switching unit and the optical interconnect unit is implemented via the optical waveguide, the optical interconnect unit comprising:
a collimating lens array in optical connection with the optical waveguide;
a control unit disposed near the collimating lens array; and
a microcontroller disposed on the surface of or inside the substrate, the microcontroller being configured to, based on an optical signal intensity measured at the signal switching unit, adjust a refractive index or a position of the collimating lens array via the control unit to improve optical coupling efficiency between the optical waveguide and the optical interconnect unit.

2. The computing module of claim 1, wherein each lens unit of the collimating lens array is made of a polymer material having an electro-optic property or a thermo-optic property; the control unit is an electrode or a heater; and the microcontroller adjusts the refractive index of the collimating lens array by controlling a current flowing through the heater or a voltage applied across the electrode, based on a deviation of the measured optical signal intensity from a setpoint.

3. The computing module of claim 1, wherein the control unit is a piezoelectric-ceramic element or a shape-memory alloy, and the microcontroller controls a voltage applied across or a current flowing through the piezoelectric-ceramic element or the shape-memory alloy to adjust the position of the collimating lens array, based on a degree of deviation of the measured optical signal intensity from a setpoint.

4. The computing module of claim 1, wherein a light-emitting surface or a light-incident surface of the collimating lens array is located on a side surface of the substrate, and the computing module further comprises a microstructure disposed on the side surface of the substrate, the microstructure being adapted to nest with a microstructure of a fiber adapter unit or a microstructure of another computing module to align the collimating lens array with a collimating lens of the fiber adapter unit or a collimating lens array of the another computing module.

5. The computing module of claim 1, wherein a light-emitting surface or a light-incident surface of the collimating lens array is located on a main surface of the substrate, and the computing module further comprises a microstructure disposed on the main surface of the substrate, the microstructure being adapted to nest with a microstructure of a fiber adapter unit.

6. The computing module of claim 5, wherein the substrate comprises a mirror surface located between the optical waveguide and the collimating lens array to guide light rays exiting from the optical waveguide to the collimating lens array or to guide light rays exiting from the collimating lens array to the optical waveguide.

7. The computing module of claim 1, wherein a light-emitting surface or a light-incident surface of the collimating lens array is located on a main surface of the substrate, and the computing module further comprises a microstructure disposed on the main surface of the substrate, wherein the microstructure is adapted to nest with a microstructure of a bridge component.

8. The computing module of claim 7, wherein the bridge component comprises a mirror surface to guide light rays exiting from the collimating lens array to a collimating lens array of another computing module or to guide light rays exiting from the collimating lens array of the another computing module to the collimating lens array.

9. The computing module of claim 7, wherein the substrate comprises a mirror surface located between the optical waveguide and the collimating lens array to guide light rays exiting from the optical waveguide to the collimating lens array or to guide light rays exiting from the collimating lens array to the optical waveguide.

10. The computing module of claim 1, wherein the data processing unit comprises an electronic integrated circuit, and the signal switching unit comprises a photonic integrated circuit.

11. The computing module of claim 1, wherein the data processing unit comprises an electronic integrated circuit and an optoelectronic converter chip, and the signal switching unit comprises an optical-switching chip.

12. A computing module, comprising: a substrate; a data processing unit disposed on a surface of or inside the substrate; a signal switching unit disposed on the surface of or inside the substrate; an optical interconnect unit; and an optical waveguide, wherein optical signal transmission between the signal switching unit and the optical interconnect unit is implemented via the optical waveguide, the optical interconnect unit comprising:
a control unit;
a collimating lens array in optical connection with the optical waveguide via the control unit; and
a microcontroller disposed on the surface of or inside the substrate, the microcontroller being configured to, based on an optical signal intensity measured at the signal switching unit, control a propagation direction of light rays between the control unit and the collimating lens array by means of the control unit to improve optical coupling efficiency between the optical waveguide and the optical interconnect unit.

13. The computing module of claim 12, wherein the control unit is a MEMS (Micro-electromechanical System) mirror, and the microcontroller is configured to control the propagation direction by adjusting a deflection angle of the MEMS mirror, based on a degree of deviation of the measured optical signal intensity from a setpoint.

14. The computing module of claim 12, wherein the control unit is a phase-only liquid crystal on silicon, and the microcontroller is configured to control the propagation direction by adjusting a phase distribution of liquid-crystal molecules in the phase-only liquid crystal on silicon, based on a degree of deviation of the measured optical signal intensity from a setpoint.

15. The computing module of claim 12, wherein a light-emitting surface or a light-incident surface of the collimating lens array is located on a side surface of the substrate, and the computing module further comprises a microstructure disposed on the side surface of the substrate, the microstructure being adapted to nest with a microstructure of a fiber adapter unit or a microstructure of another computing module to align the collimating lens array with a collimating lens of the fiber adapter unit or a collimating lens array of the another computing module.

16. The computing module of claim 12, wherein a light-emitting surface or a light-incident surface of the collimating lens array is located on a main surface of the substrate, and the computing module further comprises a microstructure disposed on the main surface of the substrate, the microstructure being adapted to nest with a microstructure of a fiber adapter unit.

17. The computing module of claim 16, wherein the substrate comprises a mirror surface located between the optical waveguide and the control unit to guide light rays exiting from the optical waveguide to the control unit or to guide light rays exiting from the control unit to the optical waveguide.

18. The computing module of claim 12, wherein a light-emitting surface or a light-incident surface of the collimating lens array is located on a main surface of the substrate, and the computing module further comprises a microstructure disposed on the main surface of the substrate, the microstructure being adapted to nest with a microstructure of a bridge component.

19. The computing module of claim 18, wherein the bridge component comprises a mirror surface to guide light rays exiting from the collimating lens array to a collimating lens array of another computing module or to guide light rays exiting from the collimating lens array of the another computing module to the collimating lens array.

20. The computing module of claim 18, wherein the substrate comprises a mirror surface located between the optical waveguide and the control unit to guide light rays exiting from the optical waveguide to the control unit or to guide light rays exiting from the control unit to the optical waveguide.

21. The computing module of claim 12, wherein the data processing unit comprises an electronic integrated circuit, and the signal switching unit comprises a photonic integrated circuit.

22. The computing module of claim 12, wherein the data processing unit comprises an electronic integrated circuit and an optoelectronic converter chip, and the signal switching unit comprises an optical-switching chip.
